(19) United States
(12) Patent Application Publication
(10) Pub. No.: US 2001/0024249 A1
(43) Pub. Date: Sep. 27, 2001

(54) Reflective display device

(76) Inventor: Jung Min Moon, Kyounggi-do (KR)

Correspondence Address: BIRCH STEWART KOLASCH & BIRCH, PO BOX 747, FALLS CHURCH, VA, 22040-0747, US

(21) Appl. No.: 09/739,674

(22) Filed: Dec. 20, 2000

(30) Foreign Application Priority Data
Dec. 31, 1999 (KR) P99-68073

(51) Int. Cl. G02F 1/1335

(52) U.S. Cl. 349/65

(57) ABSTRACT

A reflective display device that is capable of improving a light efficiency. In the device, a light guide has inclined upper surface so as to compensate a path of a light inputted from the auxiliary light source to the reflective display device to have an angle close to a vertical direction with respect to the reflective display device. Accordingly, the majority of a light outputted from the reflective display device to an observer can be progressed within an effective view range to improve a light efficiency.

### BACKGROUND OF THE INVENTION

1. Field of the Invention

This invention relates to a reflective display device, and more particularly to a reflective display device that is capable of improving a light efficiency.

2. Description of the Related Art

A liquid crystal display (LCD) is a flat panel display device having advantages of small bulk, thin thickness and low power consumption. The LCD has been used as a portable computer such as a notebook personal computer, an office automation equipment and an audio/video machinery, etc. The LCD controls an electric field applied to a liquid crystal material having a dielectric anisotrophy to transmit or shut off a light, thereby displaying a picture or an image. The LCD exploits an external light rather than generating a light by himself unlike display devices such as an electro-luminescence (EL) device, a cathode ray tube (CRT), a light emitting diode (LED) and so on.

The LCD is largely classified into a transmissive type and a reflective type depending on a method of exploiting a light. The transmissive LCD includes a liquid crystal panel having a liquid crystal material injected between two glass substrates, and a back light for supplying a light to the liquid crystal panel. However, the transmissive LCD has not only a difficulty in making a product with a thin thickness and a light weight, but also it has a drawback in that the back light has an excessive power consumption. On the other hand, the reflective LCD includes a reflective liquid crystal display panel 10 that transmit and reflect a natural light and a peripheral light to and from the display screen without a back light as shown in FIG. 1. The reflective liquid crystal panel 10 consists of a liquid crystal panel 2 in which a liquid crystal material is injected between two glass substrates, and a reflector 4 arranged at the rear side of the liquid crystal panel 2 or arranged at the interior of the liquid crystal panel to reflect a light toward the display screen. This reflective LCD does not use the back light, but reflects a natural light or a peripheral light by means of the reflector 4 so as to display a picture or an image. However, since the reflective LCD has a considerably low brightness level at a place where a natural light or a peripheral light is not sufficient, it does not permit an observer to view the displayed image. In order to solve this problem, there has been suggested a reflective LCD exploiting an auxiliary light other than a natural light.

FIG. 2 shows a conventional reflective LCD using an auxiliary surface light source. Referring to FIG. 2, the conventional reflective LCD includes a reflective liquid crystal display panel 30, and an auxiliary surface light source 32 for irradiating a light onto a display screen of the reflective liquid crystal display panel 30. The auxiliary surface light source 32 consists of a lamp 21, a lamp reflective mirror 22, a light guide 26 and a side reflective mirror 28. The lamp reflective mirror 22 surrounds the lamp 21 and plays a role to reflect a light inputted from the lamp 21 into an light-incidence surface 29 of the light guide 26. The light guide 26 plays a role to input a light from the lamp 21 to the entire display screen of the reflective liquid crystal display panel 30 at a uniform light quantity. A light outputted from the light guide 26 has to be incident to the reflective liquid crystal display panel 30 as vertically as possible in order to improve a light efficiency. To this end, the bottom surface of the light guide 26, that is, a surface opposed to the display screen of the reflective liquid crystal display panel 30 is provided with a minute protrusion pattern 27. A structure of the minute protrusion pattern 27 will be described in detail later. The side reflective mirror 28 surrounds the side surface of the light guide 26 excluding the light incidence surface 29 thereof, the bottom surface thereof provided with the minute protrusion pattern and the upper surface thereof, and plays a role to reflect a light incident to himself into the light guide 26 to prevent a light leakage. If a light leakage from the side surface of the light guide is very small or if the light leakage can be overcome using other means, then the side reflective mirror 28 may be omitted.

As shown in FIG. 3, the minute protrusion pattern 27 has a trapezoidal section. In the minute protrusion pattern 27, the A and C surfaces are inclined surfaces having an incline of about 0° to 10° at an opposite slope. The C surface refracts a light progressing from the light incidence surface 29 of light guide 26 to be reflected from the upper surface of the light guide 26 and then being incident to himself at a desired angle, toward the reflective liquid crystal display panel 30. Similarly, the A surface refracts a light reflected from the side surface opposed to the incidence surface 29 of the light guide 26 to be reflected from the upper surface of the light guide 26 in the course of being returned to the light incidence surface 29 and then being incident to himself at a desired angle, toward the reflective liquid crystal panel 30. The B surface with a plane shape exists between the A surface and the C surface of the minute protrusion pattern 27, and the D surface with a plane shape exists between the minute protrusion patterns 27. The D surface is set to have a lager width than the A surface. A light refracted by such a minute protrusion pattern 27 to be incident to the display screen of the reflective liquid crystal display panel 30 is reflected to pass through the light guide and progresses toward an observer.

When a light inputted from the auxiliary surface light source 32 to the reflective liquid crystal display panel 30 is to be incident in a direction as vertical as possible, a reflective light can be progressed at a maximal light quantity within at effective view range of an observer to increase a light efficiency. However, the reflective LCD as shown in FIG. 2 has a problem in that, since an incident light refracted by the minute protrusion pattern 27 provided at the light guide 26 to progress toward the reflective liquid crystal panel 30 fails to be refracted in a complete vertical direction, a light efficiency is decreased. In other words, if a light going from the light guide 26 into the reflective liquid crystal panel 30 is not incident in a vertical direction, then a light loss is increased. Also, a reflective light reflected from the reflective liquid crystal display panel 30 is leaked beyond an effective view range of an observer, or a light reflected from the surface, instead of a light in which an image of the reflective liquid crystal display panel 30 has been displayed, is outputted to an observer, to thereby deteriorating a quality of the displayed image.

An output angle of a light reflected from the reflective liquid crystal display panel 30 has to be close to a vertical angle (i.e., 0° ) as shown in FIG. 4 for the sake of maximizing a light efficiency. However, most output lights are outputted with an inclination of more than 45° as a result of a real measurement of an output light at the display screen of the reflective liquid crystal display panel 30.

### SUMMARY OF THE INVENTION

Accordingly, it is an object of the present invention to provide a reflective display device that is capable of improving a light efficiency.

In order to achieve these and other objects of the invention, a reflective display device according to an embodiment of the present invention includes a light guide, having an inclined upper surface, for compensating a path of a light inputted from an auxiliary light source to the reflective display device to have an angle close to a vertical direction with respect to the reflective display device.

### BRIEF DESCRIPTION OF THE DRAWINGS

These and other objects of the invention will be apparent from the following detailed description of the embodiments of the present invention with reference to the accompanying drawings, in which:

FIG. 1 is a schematic section view showing a structure of a conventional reflective liquid crystal display device;

FIG. 2 is a schematic view of the reflective liquid crystal display device mounted with a conventional auxiliary light source;

FIG. 3 is a detailed section view of the minute protrusion pattern of the light guide shown in FIG. 2;

FIG. 4 is a characteristic graph of a light reflected form the reflective liquid crystal display panel shown in FIG. 2;

FIG. 5 is a section view showing a structure of a reflective liquid crystal display device according to an embodiment of the present invention;

FIG. 6 is a detailed section view showing a structure of the light guide in FIG. 5;

FIG. 7A and FIG. 7B illustrate light paths at a medium having two boundary surfaces parallel to each other and a medium having two boundary surfaces with a certain angle of inclination, respectively; and

FIG. 8 is a characteristic graph of a light reflected from the reflective liquid crystal display panel when the upper surface of the light guide in FIG. 5 has an inclination angle of 0.167°.

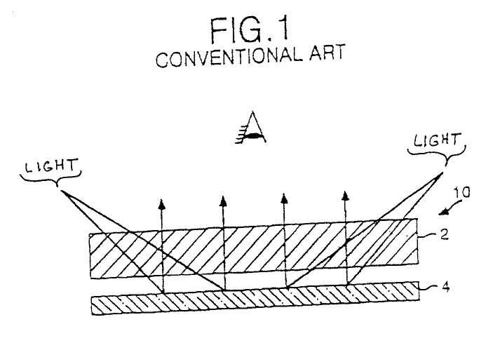

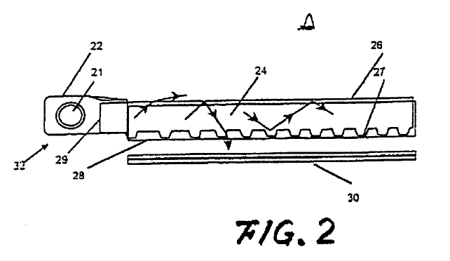

### DETAILED DESCRIPTION OF THE PREFERRED EMBODIMENT

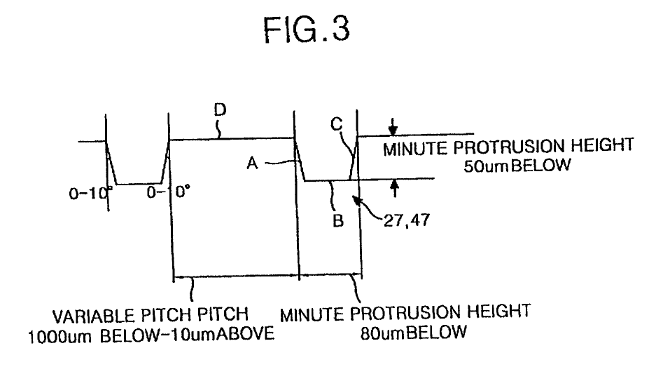

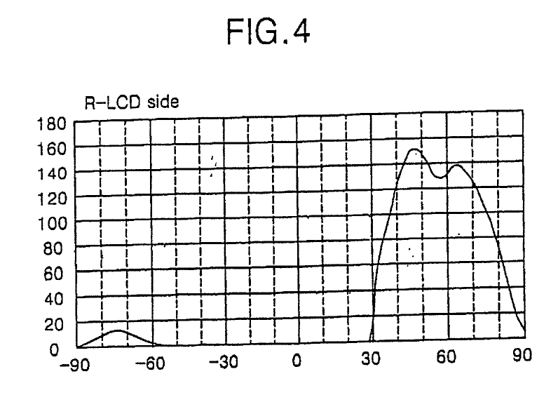

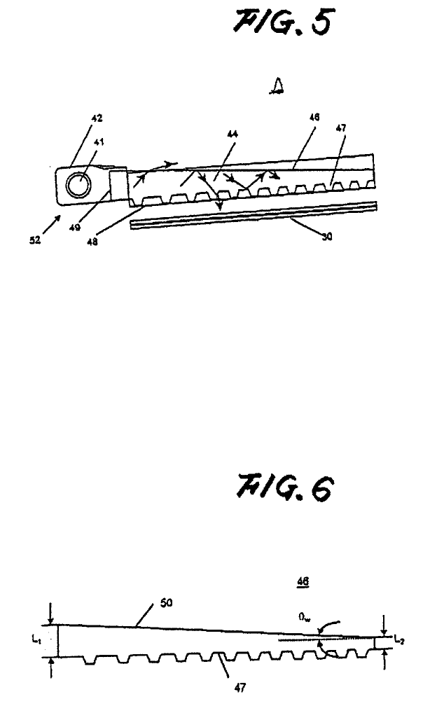

Referring to FIG. 5, there is shown a reflective liquid crystal display (LCD) according to an embodiment of the present invention. The reflective LCD includes a reflective liquid crystal display panel 30, and an auxiliary surface light source 52 including a light guide 46 having an upper surface inclined at a desired angle. The auxiliary surface light source 52 consists of a lamp 41, a lamp reflective mirror 42, a light guide 46 and a side reflective mirror 48. The lamp reflective mirror 42 surrounds the lamp 41. The light guide 46 inputs a light from the lamp 41 to the entire display screen of the reflective liquid crystal display panel 30 at a uniform light quantity. The light guide 46 has a bottom surface provided with a minute protrusion pattern 47 as shown in FIG. 3 and an upper surface 50 inclined at a desired inclination angle of θ_{W} as shown in FIG. 6 in order to refract a light inputted from the lamp 41 vertically with respect to the display screen of the reflective liquid crystal display panel 30. The side reflective mirror 48 surrounds the side surfaces of the light guide 46 excluding the light incidence surface 49 thereof, the bottom surface thereof provided with the minute protrusion pattern and the upper surface thereof, and plays a role to reflect a light incident to himself into the light guide 46 to prevent a light leakage. If a light leakage from the side surface of the light guide is very small or if the light leakage can be overcome using other means, then the side reflective mirror 48 may be omitted.

As for a shape of the minute protrusion pattern 47, as the A and C surfaces goes closer to a vertical angle (i.e., 0°) with respect to the B and D surfaces, a light from the light guide 46 into the reflective liquid crystal display panel 30 makes an incidence angle closer to a vertical angle. However, it is difficult to form the minute protrusion pattern 47 in such a manner that the A and C surfaces make a vertical angle (i.e., 0°) with respect to the B and D surfaces. Accordingly, it becomes difficult to control a light incident to the reflective liquid crystal display panel 30 in a vertical direction only by means of the minute protrusion pattern 47. For the purpose of compensating this, the upper surface 50 of the light guide 46 is inclined at a desired slope θ_{W} as shown in FIG. 6. By this inclined upper surface 50, a height L₁ of the incidence surface 49 of the light guide 46 becomes larger than a height L₂ of a surface opposed to the incidence surface 49. Otherwise, the bottom surface of the light guide provided with the minute protrusion pattern 47 is parallel to the reflective liquid crystal display panel 30.

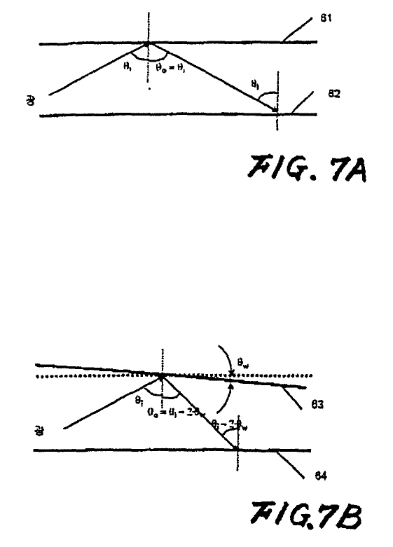

FIG. 7A and FIG. 7B compares a reflection angle of a light reflected from the upper surface of the light guide 46 when the upper surface 50 is horizontal and when the upper surface 50 is inclined. When a light is incident to a medium having boundary surfaces 61 and 62 parallel to each other at an upward slope with a desired angle as shown in FIG. 7A, an incidence angle θᵢ and a reflection angle θₒ of a light incident to the upper boundary surface 61 becomes always equal.

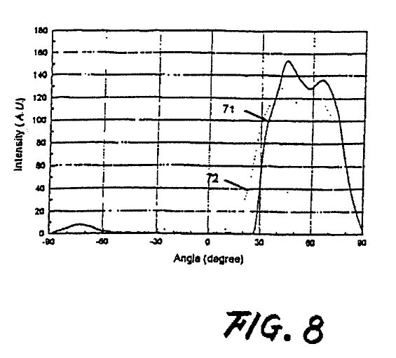

On the other hand, when a light is incident to a medium having boundary surfaces 63 and 64 that are not parallel to each other at an upward slope with a desired angle as shown in FIG. 7B, an incidence angle θᵢ and a reflection angle θₒ of a light incident to the upper boundary surface 63 does not become equal. If the lower boundary surface 64 is horizontal and the upper boundary surface 63 is inclined at an angle of θ_{W} to thereby allow the two boundary surfaces 63 and 64 not to be parallel to each other, a light incident to the upper boundary surface 63 at a desired incidence angle θᵢ is reflected at a reflection angle (i.e., θₒ=θᵢ−2θ_{W}) more refracted vertically by 2θ_{W} than the incidence angle θᵢ to be incident to the lower boundary surface 64. As seen from FIG. 7B, if the upper surface 50 of the light guide 46 is inclined at a desired angle θ_{W}, then it is able to almost vertically control a path of a light being incident to the bottom surface provided with the minute protrusion pattern. Accordingly, a light passing through the bottom surface of the light guide 46 provided with the minute protrusion pattern 47 is converted into an almost vertical angle to be incident to the display screen of the reflective liquid crystal display panel 30, and thereafter is reflected at an almost vertical angle from the reflective liquid crystal display panel 30 to be progressed within an effective view range of an observer. It can be seen from FIG. 8 that, as a result of measuring an output light at the display screen of the reflective liquid crystal display panel 30 when an inclination angle θ_{W} of the upper surface 50 of the light guide 46 has been set to 0.1670, a light output characteristic 72 of a light reflected from the output surface of the reflective liquid crystal display panel 30 is more distributed in a vertical (or 0°) direction than the light output characteristic 71 in the prior art in which the upper surface is not inclined. If an inclination angle θ_{W} of the upper surface 50 of the light guide 46 is more enlarged, then a light quantity outputted from the reflective liquid crystal display panel 30 at an angle close to the vertical (or 0°) direction becomes more increased.

It is desirable that the inclination angle θ_{W} of the upper surface 50 of the light guide 46 should be set to a value of 0.1° to 3°. When the inclination angle θ_{W} of the upper surface 50 is enlarged beyond a value of 0.1° to 3°, a light progressing within the light guide 46 fails to sufficiently progress between the incidence surface 49 of the light guide 46 and the surface opposed thereto while the majority of it is outputted to the exterior of the light guide 46 at the middle portion of the light path. In this case, a light quantity being incident to the reflective liquid crystal display panel 30 is large at a location close to the incidence surface 49 of the light guide 46, whereas a light quantity is more decreased at a location going farther toward the surface opposed to the incidence surface 49. Furthermore, if the inclination angle θ_{W} of the upper surface 50 is excessively enlarged, then a distortion of an incidence angle becomes serious when a peripheral light or a natural light other than the auxiliary light source is incident to the reflective liquid crystal display panel 30.

As described above, according to the present invention, the upper surface of the light guide is inclined at a desired angle to compensate for a path of a light being incident to the reflective display device from the light guide in such a manner to have an almost vertical angle. Accordingly, the majority of a light outputted from the reflective display device to an observer can be progressed within an effective view range to improve a light efficiency.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A reflective display device reflecting a light inputted from an auxiliary light source to display an image, said device comprising:
a light guide, having an inclined upper surface, for compensating a path of a light inputted from the auxiliary light source to the reflective display device to have an angle close to a vertical direction with respect to the reflective display device.

2. The reflective display device according to claim 1, wherein the bottom surface of the light guide opposed to the reflective display device is provided with a minute protrusion pattern for refracting a light inputted from the upper surface of the light guide in a direction perpendicular to the reflective display device.

3. The reflective display device according to claim 1, wherein an inclination angle of the upper surface of the light guide is set to a value of 0.1° to 3°.
